(19) United States
(12) Patent Application Publication
(10) Pub. No.: US 2023/0266555 A1
(43) Pub. Date: Aug. 24, 2023

(54) DIRECTED ENERGY SYSTEM

(71) Applicant: Booz Allen Hamilton Inc., McLean, VA (US)

(72) Inventors: Joshua Peters, Knoxville, TN (US); Ian Thomson, Knoxville, TN (US); James A. Davis, San Diego, CA (US)

(21) Appl. No.: 18/173,568

(22) Filed: Feb. 23, 2023

Related U.S. Application Data
(60) Provisional application No. 63/312,931, filed on Feb. 23, 2022.

(51) Int. Cl. G02B 6/44

(52) U.S. Cl. CPC G02B 6/4458; G02B 6/4477; G02B 6/448

(57) ABSTRACT

A directed energy system includes a gimbal assembly that includes a turret configured to rotate about a first axis, and a directed energy head coupled to the turret and configured to rotate about a second axis that is orthogonal to the first axis. The system further includes an optical fiber spooling ring comprised of a fiber cable at least partially threaded through the gimbal assembly and including a plurality of optical fibers configured to transmit optical energy. The optical fiber spooling ring includes a plurality of 360 degree rotations of the fiber cable.

### CROSS-REFERENCE TO RELATED APPLICATION

This application claims priority under 35 U.S.C. § 119 to U.S. Provisional Patent Application Ser. No. 63/312,931, filed on Feb. 23, 2022, the entire contents of which are incorporated herein by reference.

### BACKGROUND

For high-power laser applications such as weapon systems or industrial material processing systems, the elements of a fiber laser are often mounted in a fixed assembly, requiring a lengthy transport fiber to carry the optical power from the optical source to the output of a beam director or an optical arrangement mounted on the gimbal assembly. This is primarily due to the large size and weight of the fiber laser components, including the numerous diode pump modules required to energize the fiber laser amplifiers. Also, the diode modules require high electrical powers and a cooling capacity that would have to be serviced.

### SUMMARY

The advent of high-power, fiber lasers (both active gain fiber amplifiers and high-power transport fibers) has allowed the optical transfer to be enclosed in a single, small-diameter fiber or a bundle of multiple fibers (fiber core), enclosed in a protective sheath that is threaded through the gimbal assembly. To allow angular movement of the gimbal assembly (both around azimuth and elevation axes), the fiber length is generally laid in a tray with a continuous, wrapped belt arrangement that permits a limited rotation of the gimbal assembly while maintaining optical channel(s) through the fiber core.

For high-brightness, fiber laser systems, the power per fiber channel is limited by physical parameters that can influence the far-field irradiance of the system. Therefore, some High-Energy Laser (HEL) weapon systems or high-power industrial laser installations will require combining of the outputs from several, individual fiber amplifier channels to generate the required total system power and irradiance. If that beam combining process is performed prior to transporting the optical power through the gimbal axes, then a free-space optical path must be included in design of the gimbal assembly. The use of a fiber bundle, threaded through the gimbal z-axes, with any requisite beam combining arrangement mounted in the body of the gimbal assembly can avoid this design element.

In cases where long fibers are acceptable, this disclosure describes an approach that permits relatively flexible target engagement by increasing a range of azimuthal motion up to N number of full azimuthal turns of the gimbal assembly, where N is a number greater than or equal to one and less than about thirty.

In an example implementation, a directed energy system includes a gimbal assembly that includes a turret configured to rotate about a first axis, and a directed energy head coupled to the turret and configured to rotate about a second axis that is orthogonal to the first axis. The system further includes an optical fiber spooling ring comprised of a fiber cable at least partially threaded through the gimbal assembly and including a plurality of optical fibers configured to transmit optical energy. The optical fiber spooling ring includes a plurality of 360 degree rotations of the fiber cable.

In an aspect combinable with the example implementation, the optical fiber spooling ring is configured as a coil spring that is defined by a first length in a retracted state and a second length greater than the first length in an extended state.

In another aspect combinable with any of the previous aspects, the optical fiber spooling ring is configured to lengthen from the first length in the retracted state toward the second length as the turret rotates about the first axis for a first plurality of 360 degree rotations in a first rotational direction.

In another aspect combinable with any of the previous aspects, the optical fiber spooling ring is configured to shorten from the second length in the extended state toward the first length as the turret rotates about the first axis for a second plurality of 360 degree rotations in a second rotational direction opposite the first rotational direction.

In another aspect combinable with any of the previous aspects, the optical fiber spooling ring is biased to adjust from the extended state toward the retracted state during rotational movement in the second rotational direction.

In another aspect combinable with any of the previous aspects, the fiber cable includes a ribbon cable comprised of the plurality of optical fibers connected in a web.

In another aspect combinable with any of the previous aspects, the optical energy is in a range of 10 Watts to 1000 Watts.

In another aspect combinable with any of the previous aspects, the plurality of 360 rotations is between two 360 degree rotations and thirty 360 degree rotations.

In another aspect combinable with any of the previous aspects, the plurality of 360 rotations includes more than one 360 degree plus n rotations of the fiber cable, where n is a fraction of a 360 degree rotation of the fiber cable.

In another aspect combinable with any of the previous aspects, the optical fiber spooling ring is positioned in the turret, and the fiber cable is at least partially threaded from the turret through the directed energy head.

In another aspect combinable with any of the previous aspects, the optical fiber spooling ring is positioned in a base of the gimbal assembly, and the fiber cable is at least partially threaded from the base and to the directed energy head.

In another aspect combinable with any of the previous aspects, the optical fiber spooling ring is positioned in a yoke of the gimbal assembly, and the fiber cable is at least partially threaded from the yoke to the directed energy head.

In another aspect combinable with any of the previous aspects, the optical fiber spooling ring is positioned in the directed energy head.

In another aspect combinable with any of the previous aspects, the fiber cable includes a first terminal end coupled to a directed energy source external to the gimbal assembly; and a second terminal end coupled to a directed energy combiner in the directed energy head.

In another aspect combinable with any of the previous aspects, the directed energy source includes a plurality of directed energy amplifiers, with each of the directed energy amplifiers independently coupled to a particular one of the plurality of optical fibers at the first terminal end.

In another aspect combinable with any of the previous aspects, the directed energy combiner includes a plurality of directed energy combiners, with each of the directed energy combiners independently coupled to a particular one of the plurality of optical fibers at the second terminal end.

In another aspect combinable with any of the previous aspects, the optical energy includes laser energy.

In another aspect combinable with any of the previous aspects, the first axis includes an azimuthal axis, and the turret is configured to rotate about a plurality of 360 rotations of the azimuthal axis.

In another aspect combinable with any of the previous aspects, the second axis includes an elevation axis, and the directed energy head is configured to rotate about 100 degrees of the elevation axis.

In another example implementation, a method of delivering directed energy includes operating a directed energy system that includes a gimbal assembly including a turret and a directed energy head coupled to the turret, and an optical fiber spooling ring comprised of a fiber cable at least partially threaded through the gimbal assembly and including a plurality of optical fibers. The optical fiber spooling ring includes a plurality of 360 degree rotations of the fiber cable. The method further includes delivering optical energy through the plurality of optical fibers; controlling the turret to rotate about a first axis during delivery of the optical energy through the plurality of optical fibers; and controlling the directed energy head about a second axis orthogonal to the first axis during delivery of the optical energy through the plurality of optical fibers.

In an aspect combinable with the example implementation, the optical fiber spooling ring is configured as a coil spring that is defined by a first length in a retracted state and a second length greater than the first length in an extended state.

Another aspect combinable with any of the previous aspects further includes, during rotation of the turret about the first axis for a first plurality of 360 degree rotations in a first rotational direction, extending the optical fiber spooling ring from the first length in the retracted state toward the second length.

Another aspect combinable with any of the previous aspects further includes, during rotation of the turret about the first axis for a second plurality of 360 degree rotations in a second rotational direction opposite the first rotational direction, retracting the optical fiber spooling ring from the second length in the extended state toward the first length.

In another aspect combinable with any of the previous aspects, the optical fiber spooling ring is biased to adjust from the extended state toward the retracted state during rotational movement in the second rotational direction.

In another aspect combinable with any of the previous aspects, the fiber cable includes a ribbon cable comprised of the plurality of optical fibers connected in a web.

Another aspect combinable with any of the previous aspects further includes delivering the optical energy in a range of 10 Watts to 1000 Watts.

In another aspect combinable with any of the previous aspects, the plurality of 360 rotations is between two 360 degree rotations and thirty 360 degree rotations.

In another aspect combinable with any of the previous aspects, the plurality of 360 rotations includes more than one 360 degree plus n rotations of the fiber cable, where n is a fraction of a 360 degree rotation of the fiber cable.

In another aspect combinable with any of the previous aspects, the optical fiber spooling ring is positioned in the turret, and the fiber cable is at least partially threaded from the turret through the directed energy head.

In another aspect combinable with any of the previous aspects, the optical fiber spooling ring is positioned in a base of the gimbal assembly, and the fiber cable is at least partially threaded from the base and to the directed energy head.

In another aspect combinable with any of the previous aspects, the optical fiber spooling ring is positioned in a yoke of the gimbal assembly, and the fiber cable is at least partially threaded from the yoke to the directed energy head.

In another aspect combinable with any of the previous aspects, the optical fiber spooling ring is positioned in the directed energy head.

Another aspect combinable with any of the previous aspects further includes delivering the optical energy from a directed energy source to a first terminal end of the fiber cable coupled to the directed energy source external to the gimbal assembly; and delivering the optical energy from a second terminal end of the fiber cable coupled to a directed energy combiner in the directed energy head.

In another aspect combinable with any of the previous aspects, the directed energy source includes a plurality of directed energy amplifiers, with each of the directed energy amplifiers independently coupled to a particular one of the plurality of optical fibers at the first terminal end.

In another aspect combinable with any of the previous aspects, the directed energy combiner includes a plurality of directed energy combiners, with each of the directed energy combiners independently coupled to a particular one of the plurality of optical fibers at the second terminal end.

In another aspect combinable with any of the previous aspects, the optical energy includes laser energy.

In another aspect combinable with any of the previous aspects, the first axis includes an azimuthal axis, and controlling the turret to rotate about the first axis during delivery of the optical energy through the plurality of optical fibers includes controlling the turret to rotate about a plurality of 360 rotations of the azimuthal axis.

In another aspect combinable with any of the previous aspects, the second axis includes an elevation axis, and controlling the directed energy head about the second axis orthogonal to the first axis during delivery of the optical energy through the plurality of optical fibers includes controlling the directed energy head to rotate about 100 degrees of the elevation axis.

According to an aspect, a combination includes an optical fiber spooling ring comprised of a fiber cable having a plurality of optical fibers that are bundled together and wherein the optical fiber spooling ring has more than one 360 degree rotation of the fiber cable.

The above aspect may include amongst features described herein one or more of the following features.

The optical fibers of the optical fiber spooling ring are configured to carry optical energy. The optical energy carried by the optical fibers of the optical fiber spooling ring is in a range of 10 Watts to 1000 Watts, and in some aspects up to 20 kW or up to 50 kW or more. The optical fiber spooling ring has at least two 360 degree rotations of the fiber cable. The optical fiber spooling ring has at least two 360 degree rotations of the fiber cable up to thirty 360 degree rotations of the fiber cable. The optical fiber spooling ring has more than one 360 degree plus n rotations of the fiber cable, where n is a fraction of a 360 degree rotation of the fiber cable. The optical fiber spooling ring has at least two 360 degree rotations of the fiber cable up to thirty 360 degree rotations of the fiber cable, plus an n rotation of the fiber cable, where n is a fraction of a 360 degree rotation of the fiber cable.

According to an aspect, a combination includes an optical fiber spooling ring having a first terminus and second terminus and comprised of a fiber cable having a plurality of optical fibers that are bundled together and wherein the optical fiber spooling ring has at least one 360 degree rotation of the fiber cable, and a gimbal assembly having a frame and a mount, with the first terminus of the optical fiber spooling ring affixed to the frame and the second terminus of the optical fiber spooling ring affixed to the mount.

The above aspect may include amongst features described herein one or more of the following features.

The optical fibers of the optical fiber spooling ring are configured to carry optical energy. The optical energy carried by the optical fibers of the optical fiber spooling ring is in a range of 10 Watts to 1000 Watts (and even up to 20 kW or 50 kW or more). The optical fiber spooling ring has at least two 360 degree rotations of the fiber cable. The optical fiber spooling ring has at least two 360 degree rotations of the fiber cable up to thirty 360 degree rotations of the fiber cable. The optical fiber spooling ring has more than one 360 degree plus n rotations of the fiber cable, where n is a fraction of a 360 degree rotation of the fiber cable. The optical fiber spooling ring has at least two 360 degree rotations of the fiber cable up to thirty 360 degree rotations of the fiber cable, plus an n rotation of the fiber cable, where n is a fraction of a 360 degree rotation of the fiber cable.

One or more of the above aspects may provide one or more of the following advantages. The use of the optical fiber spooling ring permits an increase in a number of rotations of a gimbal assembly according to the number N of rotations of an optical fiber cable within the optical fiber spooling ring while keeping the beam contained within optical fibers of the optical fiber spooling ring. In addition, the optical fiber spooling ring may provide benefits in optical performance through improved control or coordination of fiber bending.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B illustrate an example implementation of an optical fiber spooling ring for a directed energy system in a retracted and an extended state, respectively, according to the present disclosure.

FIG. 2 illustrates a gimbal assembly for a directed energy system according to the present disclosure.

FIGS. 3 and 4 are schematic diagrams of example implementations of directed energy systems that include an optical fiber spooling ring and gimbal assembly according to the present disclosure.

FIGS. 5A-5E illustrate example implementations of a gimbal assembly and optical fiber spooling ring for a directed energy system according to the present disclosure.

FIG. 6 is a schematic illustration of a control system for a directed energy system according to the present disclosure.

### DETAILED DESCRIPTION

Directed energy systems, such as high energy lasers, can lack compatibility with a fiber-optic “slip ring,” that limits, for example, an amount of rotation or rotations (in one or two rotational directions) that a gimbal assembly or turret of the directed energy system can make before reaching a limit of what an optical fiber can tolerate without damage or performance degradation. In this description, a length of optical fibers (e.g., in the form of a “ribbon cable”) are spooled into a roll, with one or more turns, so as to increase the amount of rotation that a gimbal assembly/turret associated with the high energy laser, can turn, i.e., rotate.

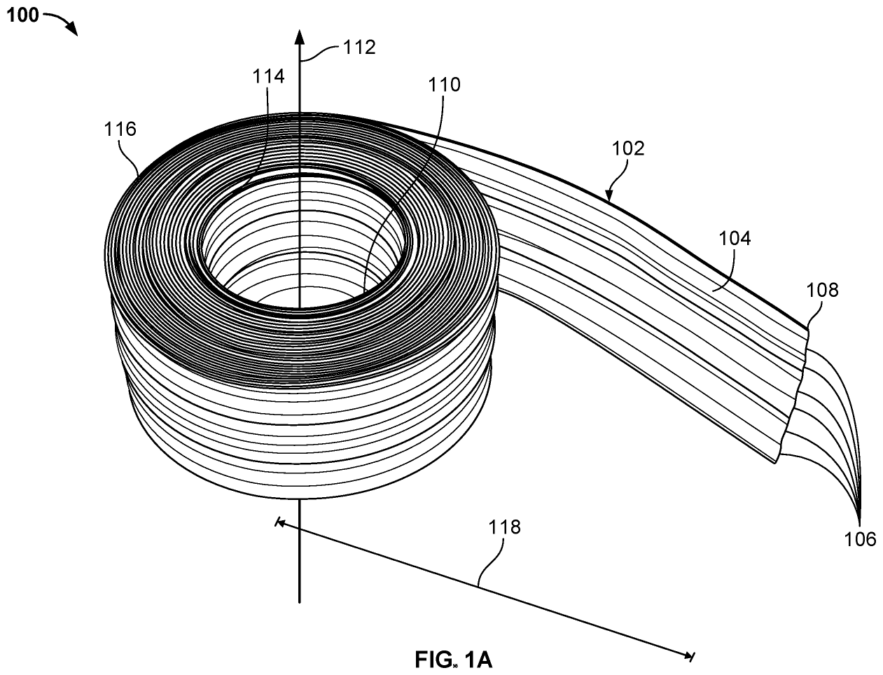

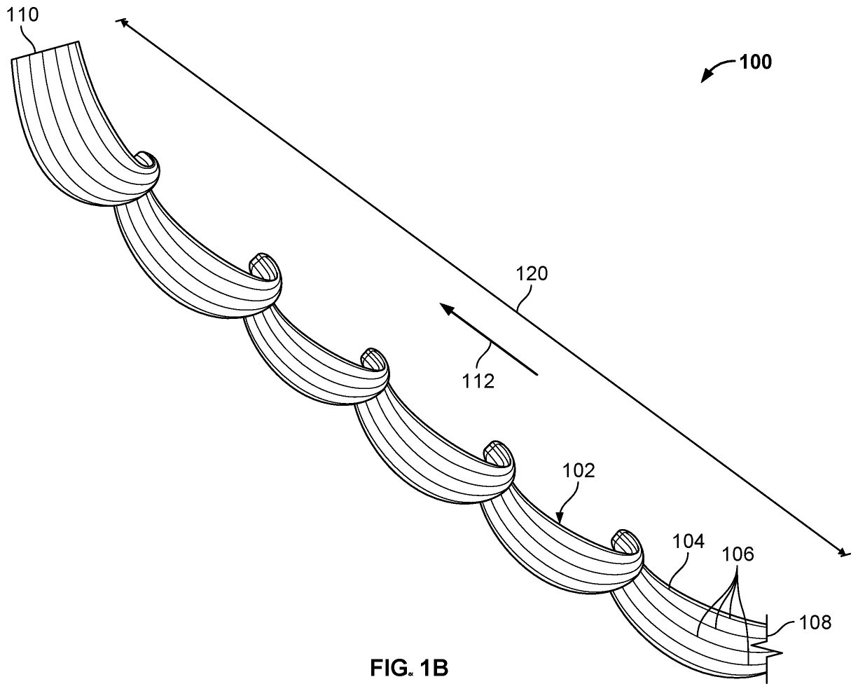

Referring now to FIG. 1A, an optical fiber spooling ring 100 for a directed energy system (described herein) is shown. The optical fiber spooling ring 100 includes plural optical fibers 106 enclosed or integrated into a web 104 to form a fiber cable 102. In this example, the fiber cable 102 comprises or is formed as a ribbon cable in that a width, W, of the fiber cable 102 is greater (and in some aspects, much greater) than a thickness, T, of the fiber cable 102.

In this example implementation, the optical fibers 106 are configured to carry optical energy (e.g., in a range of 10 Watts to 1000 Watts (or more)) per optical fiber 106. In practice the optical fiber spooling ring 100 includes many optical fibers 106, such as 10 to 20 to 30 or more optical fibers per optical fiber spooling ring 100.

Optical fibers 106 (each carrying, e.g., 10 W to 1000 W or more of optical energy, e.g., visible light or ultraviolet light) are held together and arranged as an array of fibers (e.g., linear, rectangular, hexagonal, helical, etc.) and are bundled and/or adhered in that arrangement by the web 104. The web 104 can be a flexible material, e.g., a rubber, provided from the fiber cable 102.

The fiber cable 102 can be rolled (or spooled) to form a spiral that provides the optical fiber spooling ring 100. For example, as shown in FIG. 1A, the optical fiber spooling ring 100 is in the retracted state in which the fiber cable 102 is spooled into a number of rotations (or turns), N, with a first rotation 114 being an innermost rotation of the spool and an N rotation being an outermost rotation 116 of the spool of the fiber cable 102. As shown, the spool of the fiber cable 102 includes rotations about an axis 112. In the retracted state as shown in FIG. 1A, the fiber cable 102 can have a length 118 that can be a shortest length in which the fiber cable 102 can be retracted.

The individual optical fibers 106 at one end of the optical fiber spooling ring 100 rotate in an axis of rotation, e.g., azimuth, in the frame of reference of a gimbal assembly, while the individual fibers 106 at the other end of the optical fiber spooling ring 100 can be fixed in the frame of the gimbal's mount. Azimuth is generally regarded as an axis of rotation normal to the earth. However, there may be other uses in other orientations. Azimuth is defined an axis of rotation normal to the earth and an axis of rotation encompasses azimuth and axis's in other orientations. Azimuth will be described as the axis of rotation below.

Rotation of the gimbal assembly in the azimuth axis causes the optical fiber spooling ring 100 to wind and unwind. The amount of winding/unwinding of the optical fiber spooling ring 100 is related to the amount of gimbal assembly rotation relative to the number of turns “N” in the optical fiber spooling ring 100.

The inside or the outside of the optical fiber spooling ring 100 may be fixed to the gimbal mount's frame of reference (and vice versa for the gimbal's azimuthal frame of reference). The optical fiber spooling ring 100 carries optical energy that originates in fiber-coupled optical diodes or may be connected via a connector or may be fusion-spliced into such optical diodes or other optical fibers associated with a laser weapon. The optical fiber spooling ring 100 may terminate in a beam combiner, in connectors, or in fusion splices into other optical fibers associated with the laser weapon.

The optical fiber spooling ring 100 may be used in azimuth or elevation or both as described further herein. In some examples, if used in both azimuth and elevation, two optical fiber spooling rings 100 can be spliced or connected via connectors, whereas if fibers are contiguous, the array may be maintained or relaxed to permit more rapid reorientation from the azimuthal to the elevation axis of rotation. One or more optical fiber spooling rings 100 may be used for one or more axes of rotation (e.g., for reasons of cost, modularity, serviceability, etc.). In some aspects, a single optical fiber spooling ring 100 can be used in a gimbal assembly that rotates in two axes of rotation.

The optical fiber spooling ring 100 includes one or more loops (where a loop is 360 degrees or a fraction of a loop, e.g., less than 360 degrees) of the fiber cable 102 array of optical fibers 106. The optical fiber spooling ring 100 thus can include a minimum of one rotation, up to N+n loops, where n is a fraction (e.g., less than 360 degrees) of a loop (or turn or rotation), which can be any number of degrees between 0 degrees and 360 degrees.

Thus, the number of loops (or turns), N, is at least one complete loop (360 degrees) up to 3 (1080 degrees), up to 5 (1800 degrees), up to 10 (3600 degrees), up to 20 or more loops (7,200 degrees) or 30 loops (10,800 degrees) and fractional loop n thereof. In some aspects, N, can be greater (e.g., by an order of magnitude) than a number of rotations in which a gimbal assembly of a directed energy system can turn (e.g., in a particular rotational direction). In some aspects, a ratio of N to the number of rotations can affect or determine how much the optical fiber spooling ring 100 will increase in diameter as the gimbal assembly turns.

The number of loops N improves the control of the bending of individual optical fibers during turning of a gimbal assembly and thus reduce damage or degradation of laser performance and/or increase the extent of permissible azimuthal gimbal rotation. The optical fiber spooling ring 100 enhances fiber management (to minimize fiber damage, heating, or beam degradation) and/or enables increased rotation of one or more gimbal axes-of-rotation.

In some embodiments, a gimbal assembly (or other device) keeps track of the number of rotations of the gimbal assembly, so as to not exceed a given, maximum number of turns, e.g., N, of the gimbal assembly and thus avoid damage to the optical fiber spooling ring 100. When a gimbal assembly detects that the maximum number has been reached, the gimbal assembly needs to reset the optical fiber spooling ring 100, by winding down the gimbal assembly in an opposite rotational direction, e.g., counter-clockwise, if a gimbal assembly had been swinging clockwise, or clockwise, if the gimbal assembly had been swinging counter-clockwise.

For example, in some aspects, a control system for the directed energy system can count or keep track of a number of rotations made by the gimbal assembly (e.g., in a particular rotations direction). The control system (or gimbal assembly itself) can provide an operator with an indication that permit the operator to “reset” the optical fiber spooling ring 100 (e.g., from the extended state to the retracted state) at the least-inconvenient moment (which might only be necessary at routine maintenance intervals).

As further shown in this example implementation, the fiber cable 102 includes terminal ends 108 and 110. In some aspects, as explained more fully herein, terminal end 108 can be connected to a directed energy source, such as one or more directed energy amplifiers. In some aspects, there can be a one to one ratio of optical fibers 106 to directed energy amplifiers (such as, for example, ten optical fibers 106 and tern directed energy amplifiers). Thus, in some aspects, each optical fiber 106 is connected to one (and only one, in some cases) directed energy amplifier or other component of a directed energy source. In alternative aspects, there can be a different ratio (e.g., 2 to 1, 3 to 1, 1 to 2, etc.) of optical fibers 106 to directed energy amplifiers.

FIG. 1B, shows the optical fiber spooling ring 100 in an extended state (such as a fully extended state). In the extended state, the turns (or rotations) N of the spooling ring 100 can be unwound to provide for a length 120 of the fiber cable 102 (that can be longer than, and in some aspects, two or more orders of magnitude longer than, the retracted length 118).

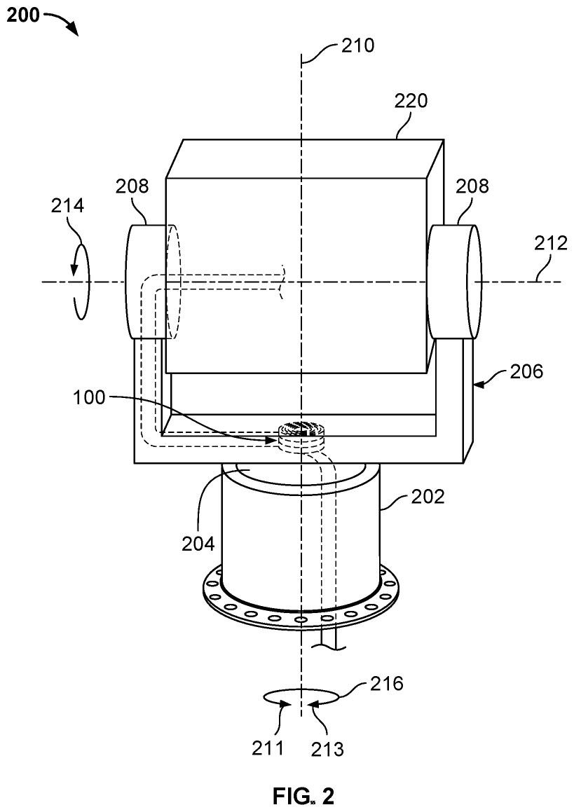

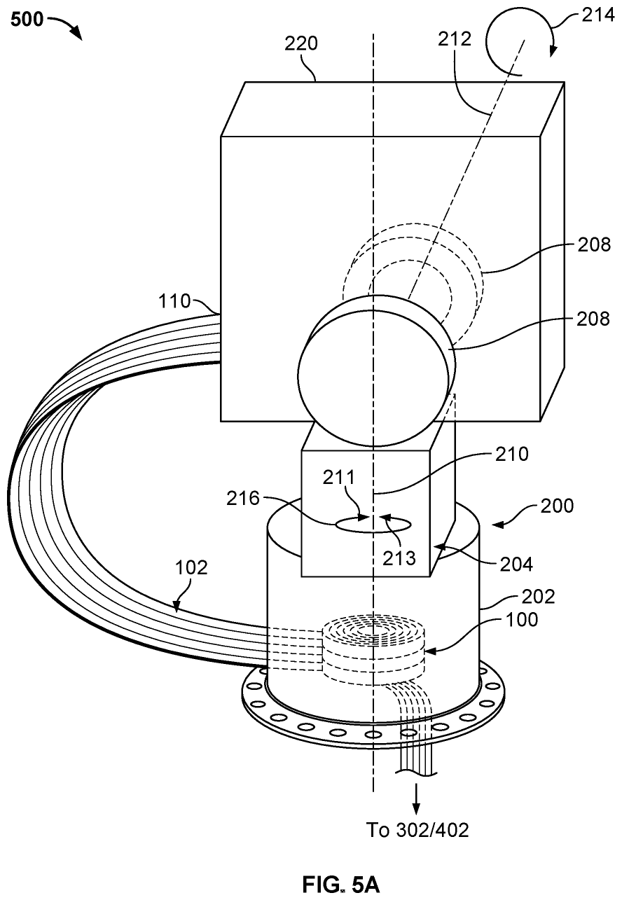

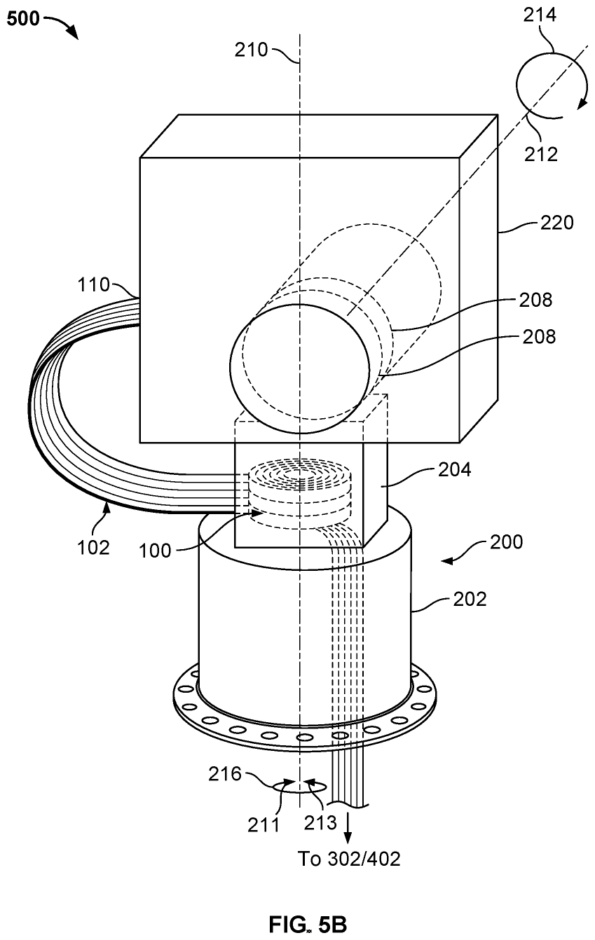

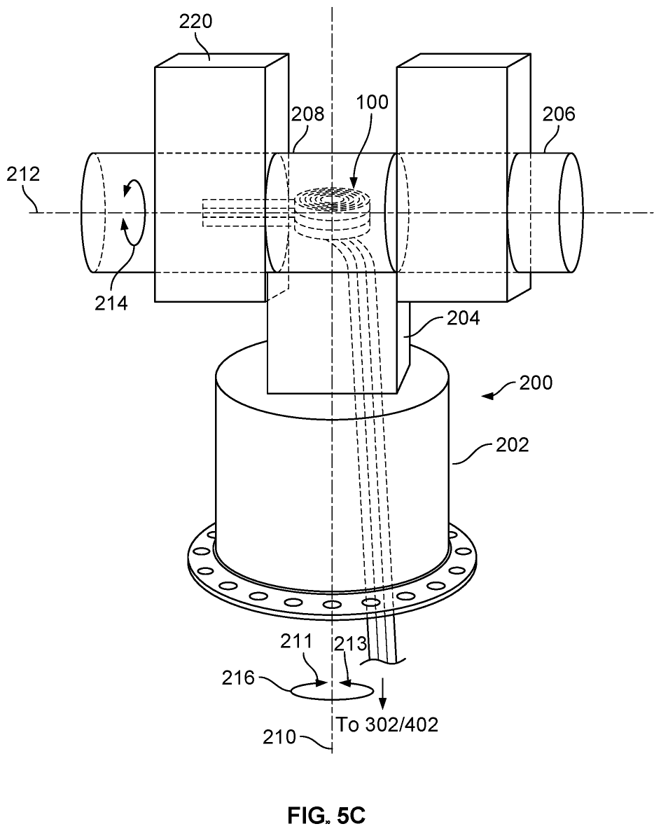

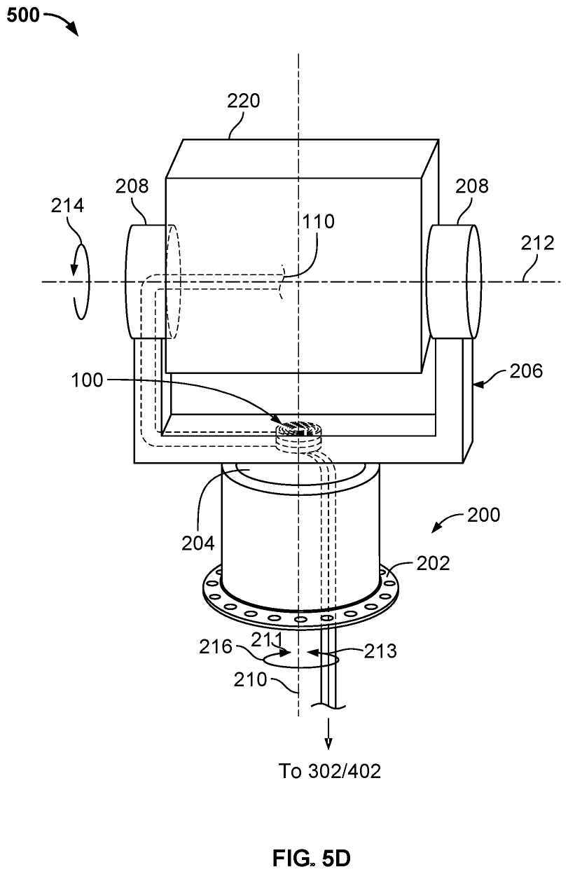

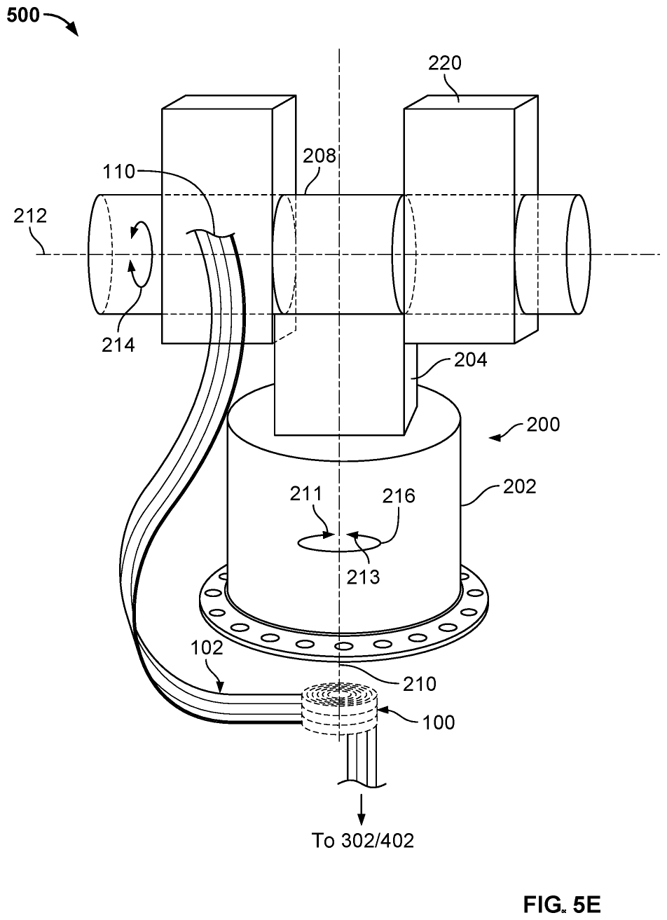

FIG. 2 illustrates a gimbal assembly 200 for a directed energy system according to the present disclosure. As shown in FIG. 2, the optical fiber spooling ring 100 can be positioned in the gimbal assembly 200 (with various implementations also shown in FIGS. 5A-5E). In this example implementation, the gimbal assembly 200 includes a base 202 that can be affixed to another structure, such as, for example, a vehicle (ground or airborne) that includes a directed energy system. Thus, in some aspects, the base 202 can provide a stationary mounting component and support for the gimbal assembly 200. The gimbal assembly 200 further includes a turret 204 coupled to the base 202 and rotatable about a first axis 210 that extends (in this drawing) vertically through a centerline of the gimbal assembly 200. The turret 204 can be coupled to the base 202 for controllable bi-directional rotation 216, such as in a first rotational direction 211 (e.g., clockwise) and a second rotational direction 213 (e.g., counter-clockwise). The turret 204 can therefore rotate freely through N rotations of 360 degrees (or portions thereof) in both the first and second rotational directions 211 and 213 (e.g., 360 degrees, 720 degrees, 1080 degrees, and so on in each direction). In some aspects, however, the base 202 is rotatable in the first and second rotational directions 211 and 213 and the turret 204 is fixed to the base 202 (and rotates with the base 202 but not independent of the base 202).

As shown in this example, the gimbal assembly 200 includes a cradle 206 mounted to the turret 204. The cradle 206, in this example, includes one or more mounting arms 208 in which a directed energy (i.e., laser) head 220 is mounted. Generally, the directed energy head 220 is connected to the fiber cable 102 of the optical fiber spooling ring 100 to output directed energy (e.g., a laser) that is supplied through the fiber cable 102 towards a target. In some aspects, the directed energy head 220 includes directed energy components that combine, focus, enhance, or otherwise adjust directed energy supplied through the fiber cable 102.

In this example of the gimbal assembly 200, the cradle 206 is controllably rotatable about a second axis 212 with bi-directional rotation as shown. Alternatively, the directed energy head 220 is controllably rotatable within the cradle 206 (e.g., within the one or more arms 208) about the second axis 212, which, as shown, is directed generally horizontal through the gimbal assembly 200 and orthogonal to the first axis 210.

In this example, the first axis 210 can be an azimuthal axis 210 about which the turret 204 (or base 202) and thus the directed energy head 220 that outputs directed energy toward a target can rotate (with N rotations of 360 degrees or portions thereof). Generally, rotation about the azimuthal axis 210 represents rotation around the horizon of the Earth in 360 (or more) degrees. The second axis 212 can be an elevation axis 212 about which the cradle 206 and/or the directed energy head 220 that outputs directed energy toward a target can rotate. Generally, rotation about the elevation axis 212 represents rotation between the Earth's surface and a direction normal to the Earth's surface (i.e., vertically upward from a point on the Earth's surface). Rotation about the elevation axis 210 can generally be between −10 degrees (i.e., between the location of the directed energy head 220 and the horizon, so as to point below the horizon) and 90 degrees (i.e., normal). Thus, the directed energy head 220 (in certain examples) may rotate about 100 degrees around the elevation axis 212.

Rotation 216 and rotation 214 can occur simultaneously or in series and be controllable, such as by a directed energy targeting system (not shown). The directed energy targeting system, generally, can perform operations such as selecting a target for directed energy output from the directed energy head 220, determining a location to output the directed energy from the head 220 to hit the target, and controlling one or more components of the gimbal assembly 200 to rotate or move (e.g., with motors or actuators or other drivers) in order to position the directed energy head 220 at particular azimuth and elevation angles to output directed energy to the location. These operations can occur and/or be adjusted in real-time (and repeated) based on movement or location of the target.

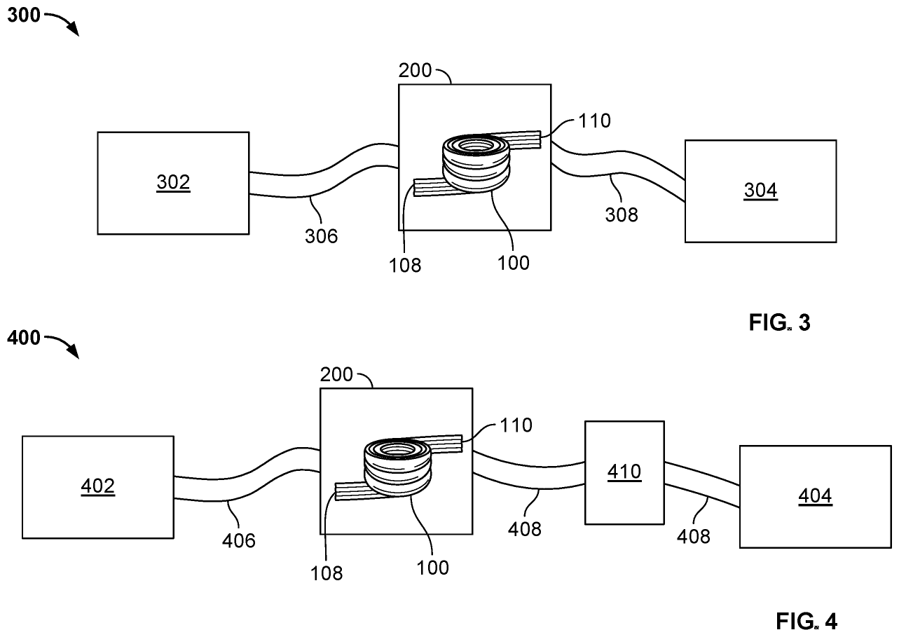

FIGS. 3 and 4 are schematic diagrams of example implementations of directed energy systems 300 and 400 that include an optical fiber spooling ring 100 and gimbal assembly 200 according to the present disclosure. Referring to FIG. 3, this example implementation of directed energy system 300 that includes the optical fiber spooling ring 100 exploits a separation of elements of laser-based energy (e.g., weapons) systems to permit flexibility in the relative motion (e.g., rotation) of portions of the directed energy system. For example, the optical fiber spooling ring 100 enables the provision of a directed energy source 302 (e.g., including laser pump diodes and their associated power and cooling systems, amplifiers, etc.) in one location, while allowing the relatively lightweight (compared to source 302) directed energy output 304 (including, for example, directed energy head 220) that includes, for instance, optical-to-optical laser equipment, to rotate on the gimbal assembly 200 or turret 204 through one or more turns, while providing tight physical coupling of optical gain stages and directed energy output 304 (including, for example, beam combination equipment). The optical fiber spooling ring 100 can offer potential advantages in length-reduction of output fibers (concomitant with linewidth and/or power advantages), as well as potential advantages in sealing, cooling, size, weight, and/or environmental robustness on account of packaging and isolation opportunities introduced by this arrangement.

As shown in this example, fiber optic cable 306 connects (e.g., optically) the fiber cable 102 with the directed energy source 302 at terminal end 108. In some aspects, fiber optic cable 306 can comprise multiple optical fiber cables, each of which is connected to one or more optical fibers 106 of the fiber cable 102. Thus, in some aspects, there is a 1 to N ratio of the fiber cable 102 to the fiber optic cables 306, in which N is the number of optical fibers 106 in the fiber cable 102. Other ratios are also contemplated by the present disclosure as well.

As shown in this example, fiber optic cable 308 connects (e.g., optically) the fiber cable 102 with the directed energy output 304 at terminal end 110. In some aspects, fiber optic cable 308 can also comprise multiple optical fiber cables, each of which is connected to one or more optical fibers 106 of the fiber cable 102. Thus, in some aspects, there is a 1 to N ratio of the fiber cable 102 to the fiber optic cables 308, in which N is the number of optical fibers 106 in the fiber cable 102. Other ratios are also contemplated by the present disclosure as well.

Referring now to FIG. 4, this example implementation of directed energy system 400 that includes the optical fiber spooling ring 100 also can exploit a separation of elements of laser-based energy (e.g., weapons) systems to permit flexibility in the relative motion (e.g., rotation) of portions of the directed energy system. For example, the optical fiber spooling ring 100 enables the provision of a directed energy source 402 (e.g., including laser pump diodes and their associated power and cooling systems, amplifiers, etc.) in one location, while allowing the relatively lightweight (compared to source 302) directed energy output 40 (including, for example, directed energy head 220) that includes, for instance, optical-to-optical laser equipment, to rotate on the gimbal assembly 200 or turret 204 through one or more turns, while providing tight physical coupling of optical gain stages and directed energy output 404 (including, for example, beam combination equipment).

In this example, directed energy output equipment can be split up between gain stages 410 and the directed energy output 404 to provide further flexibility. For example, in the directed energy system 400, a laser, amplifier, or resonator with multiple gain stages may be physically separated into 410 by the optical fiber spooling ring 100 such that one or more gain stages 410 exist on each end of an optical fiber spooling ring 100 (not shown). Alternatively, all gain stages 410 may exist on one side of the optical fiber spooling ring 100 as shown in FIG. 4, while optical sources 402 (e.g., diodes) exist on the other side of the optical fiber spooling ring 100 (optionally to include electrical power conversion and other equipment). The terminal ends 108 and 110 of the optical fiber spooling ring 100 can be connected to other fibers through splices, connectors, or contiguous fiber lengths originating in pump diodes or diode modules and/or ending in fiber couplings.

The optical fiber spooling ring 100 can offer potential advantages in length-reduction of output fibers (concomitant with linewidth and/or power advantages), as well as potential advantages in sealing, cooling, size, weight, and/or environmental robustness on account of packaging and isolation opportunities introduced by this arrangement.

As shown in this example, fiber optic cable 406 connects (e.g., optically) the fiber cable 102 with the directed energy source 402 at terminal end 108. In some aspects, fiber optic cable 406 can comprise multiple optical fiber cables, each of which is connected to one or more optical fibers 106 of the fiber cable 102. Thus, in some aspects, there is a 1 to N ratio of the fiber cable 102 to the fiber optic cables 406, in which N is the number of optical fibers 106 in the fiber cable 102. Other ratios are also contemplated by the present disclosure as well.

As shown in this example, fiber optic cable 408 connects (e.g., optically) the fiber cable 102 with the gain stages 410 and then to the directed energy output 404 at terminal end 110. In some aspects, fiber optic cable 408 can also comprise multiple optical fiber cables, each of which is connected to one or more optical fibers 106 of the fiber cable 102. Thus, in some aspects, there is a 1 to N ratio of the fiber cable 102 to the fiber optic cables 408, in which N is the number of optical fibers 106 in the fiber cable 102. Other ratios are also contemplated by the present disclosure as well.

FIGS. 5A-5E illustrate example implementations of the gimbal assembly 200 and optical fiber spooling ring 100 for a directed energy system according to the present disclosure. Generally, each of these figures show an example implementation of a directed energy assembly 500 that includes the gimbal assembly 200 with the optical fiber spooling ring 100 positioned in different locations to highlight the flexibility that the spooling ring 100 provides in allowing multi-turn rotation of the gimbal assembly 200 (e.g., more than 360 degrees in either of two azimuthal rotational directions).

In some aspects, the optical fiber spooling ring 100 can provide this flexibility by, as previously discussed, being comprised of a ribbon cable fiber cable 102 that can elongate from the retracted state shown in FIG. 1A (and retracted length 118) toward the extended state shown in FIG. 1B (and extended length 120) based on rotations in the azimuthal and/or elevation axes as described. Further, such elongation can still occur without damage to the optical fibers 106 in the fiber cable 102.

In some aspects, the optical fiber spooling ring 100 can provide this flexibility through biasing of the fiber cable 102 (e.g., as a ribbon cable) toward the retracted state when elongated. For example, rotation (e.g., azimuthal) in a first rotational direction 211 can elongate the fiber cable 102. Upon counter rotation, i.e., rotation in the second rotational direction 213, the fiber cable 102 can be biased to return (e.g., automatically, without further intervention) from the extended state (or some length between fully retracted and fully extended) toward the retracted state during the counter rotation, much like a coil spring returning from extension to a compressed state.

FIG. 5A shows the optical fiber spooling ring 100 mounted in the base 202 of the gimbal assembly 200. In this example, a portion of the fiber cable 102 that ends in terminal end 110 is threaded from the base 202 to the directed energy head 220 (external to the gimbal assembly 200 or through the turret 204 and/or cradle 206). Another portion of the fiber cable 102 that ends in terminal end 108 can be threaded through the base 202 toward the directed energy source (302 or 402).

FIG. 5B shows the optical fiber spooling ring 100 mounted in the turret 204 of the gimbal assembly 200. In this example, a portion of the fiber cable 102 that ends in terminal end 110 is threaded from the turret 204 to the directed energy head 220 (external to the gimbal assembly 200 or through the cradle 206). Another portion of the fiber cable 102 that ends in terminal end 108 can be threaded through the base 202 toward the directed energy source (302 or 402).

FIG. 5C shows the optical fiber spooling ring 100 mounted in the arm 208 (or an arm 208 of multiple arms 208) of the cradle 206 of the gimbal assembly 200. In this example, a portion of the fiber cable 102 that ends in terminal end 110 is threaded from the arm 208 to the directed energy head 220 (e.g., through the cradle 206 or arm 208). Another portion of the fiber cable 102 that ends in terminal end 108 can be threaded through the base 202 toward the directed energy source (302 or 402).

FIG. 5D shows the optical fiber spooling ring 100 mounted in the cradle 206 of the gimbal assembly 200. In this example, a portion of the fiber cable 102 that ends in terminal end 110 is threaded from the cradle 206 to the directed energy head 220 (external to the gimbal assembly 200 or through the cradle 206). Another portion of the fiber cable 102 that ends in terminal end 108 can be threaded through the base 202 toward the directed energy source (302 or 402).

FIG. 5E shows the optical fiber spooling ring 100 mounted external to the gimbal assembly 200. In this example, a portion of the fiber cable 102 that ends in terminal end 110 is extended to the directed energy head 220 (external to the gimbal assembly 200 or through one or more components of the gimbal assembly 200). Another portion of the fiber cable 102 that ends in terminal end 108 can be extended toward the directed energy source (302 or 402).

An example operation of any of the implementations of the directed energy assembly 500 illustrates the functionality of the optical fiber spooling ring 100 in combination with the gimbal assembly 200. For instance, once the fiber optic cable is connected to the directed energy head 220, as well as a directed energy source (302 or 402), a targeting system can locate a target toward which directed energy (e.g., optical energy such as a laser) can be transmitted from the directed energy source, through the fiber cable 102 (and other fiber optic cables as needed), and through the directed energy head 220.

In targeting the target, azimuthal and/or elevation rotation may be required. In an example, a first target is located and requires azimuthal rotation of, e.g., 270 degrees about the azimuthal axis in a first rotational direction. The turret 204, for instance, is controllably rotated 270 degrees, thereby extending the fiber cable 102 from the retracted state toward the extended state. Directed energy can then be output toward the first target. A second target is then located and requires azimuthal rotation of, e.g., an additional 300 degrees about the azimuthal axis in the first rotational direction. The turret 204, for instance, is controllably rotated an additional 300 degrees, thereby further extending the fiber cable 102 toward the extended state. Directed energy can then be output toward the second target. A third target is then located and requires azimuthal rotation of, e.g., 90 degrees about the azimuthal axis in a second rotational direction opposite the first rotational direction. The turret 204, for instance, is controllably rotated 90 degrees in the second rotational direction, thereby retracting the fiber cable 102 from toward the retracted state through the biasing action of the fiber cable 102. Directed energy can then be output toward the third target. Further targets can be acquired, thereby causing rotation of the gimbal assembly 200 about the azimuthal axis (in either rotational direction) and extension or retraction of the fiber cable 102 about the optical fiber spooling ring 100 as needed. Of course, rotation of at least a portion of the gimbal assembly 200 about the elevation axis can occur in series or parallel with the described rotation about the azimuthal axis in acquiring targets and outputting directed energy at such targets. Rotation about the elevation axis can also cause extension or retraction of the fiber cable 102 about the optical fiber spooling ring 100 as needed.

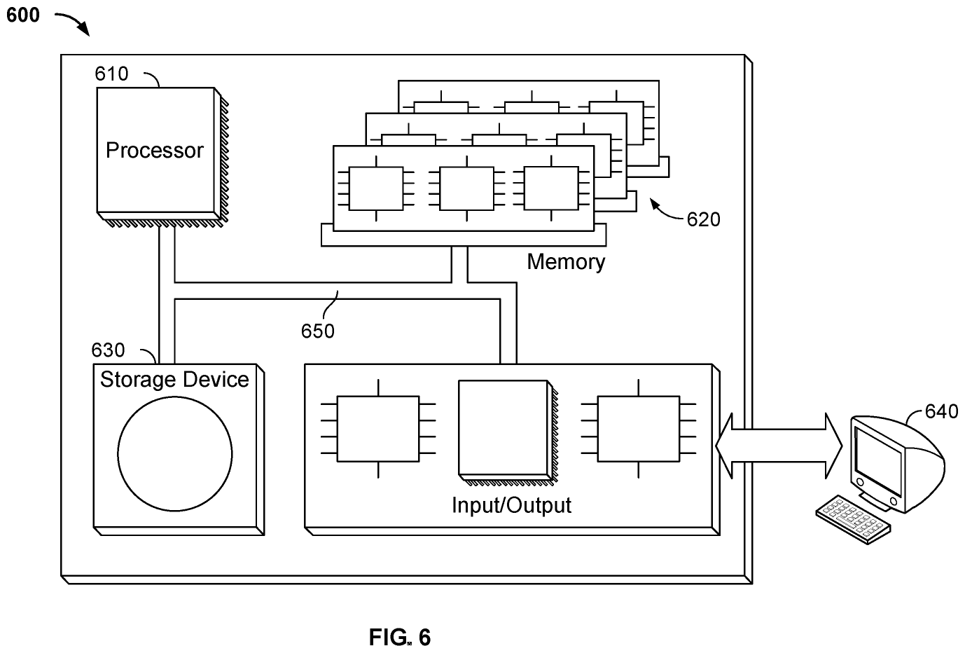

FIG. 6 is a schematic illustration of an example control system 600 for a directed energy system according to the present disclosure. For example, all or parts of the control system (or controller) 600 can be used, e.g., to control rotation of the gimbal assembly 200, targeting and operation of the laser head 220, or otherwise). The controller 600 can also include or be communicably coupled with motors, actuators, sensors, or other components of the directed energy system that facilitate rotation of the gimbal assembly 200 (all or parts thereof). The controller 600 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output device 640. Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the control system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, a tape device, flash memory, a solid state device (SSD), or a combination thereof.

The input/output device 640 provides input/output operations for the controller 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A directed energy system, comprising:
a gimbal assembly, comprising:
a turret configured to rotate about a first axis, and
a directed energy head coupled to the turret and configured to rotate about a second axis that is orthogonal to the first axis; and
an optical fiber spooling ring comprised of a fiber cable at least partially threaded through the gimbal assembly and comprising a plurality of optical fibers configured to transmit optical energy, the optical fiber spooling ring comprising a plurality of 360 degree rotations of the fiber cable.

2. The directed energy system of claim 1, wherein the optical fiber spooling ring is configured as a coil spring that is defined by a first length in a retracted state and a second length greater than the first length in an extended state.

3. The directed energy system of claim 2, wherein the optical fiber spooling ring is configured to lengthen from the first length in the retracted state toward the second length as the turret rotates about the first axis for a first plurality of 360 degree rotations in a first rotational direction.

4. The directed energy system of claim 3, wherein the optical fiber spooling ring is configured to shorten from the second length in the extended state toward the first length as the turret rotates about the first axis for a second plurality of 360 degree rotations in a second rotational direction opposite the first rotational direction.

5. The directed energy system of claim 4, wherein the optical fiber spooling ring is biased to adjust from the extended state toward the retracted state during rotational movement in the second rotational direction.

6. The directed energy system of claim 1, wherein the fiber cable comprises a ribbon cable comprised of the plurality of optical fibers connected in a web.

7. The directed energy system of claim 1, wherein the optical energy is in a range of 10 Watts to 1000 Watts.

8. The directed energy system of claim 1, wherein the plurality of 360 rotations is between two 360 degree rotations and thirty 360 degree rotations.

9. The directed energy system of claim 1, wherein the plurality of 360 rotations comprises more than one 360 degree plus n rotations of the fiber cable, where n is a fraction of a 360 degree rotation of the fiber cable.

10. The directed energy system of claim 1, wherein the optical fiber spooling ring is positioned in the turret, and the fiber cable is at least partially threaded from the turret through the directed energy head.

11. The directed energy system of claim 1, wherein the optical fiber spooling ring is positioned in a base of the gimbal assembly, and the fiber cable is at least partially threaded from the base and to the directed energy head.

12. The directed energy system of claim 1, wherein the optical fiber spooling ring is positioned in a yoke of the gimbal assembly, and the fiber cable is at least partially threaded from the yoke to the directed energy head.

13. The directed energy system of claim 1, wherein the optical fiber spooling ring is positioned in the directed energy head.

14. The directed energy system of claim 1, wherein the fiber cable comprises:
a first terminal end coupled to a directed energy source external to the gimbal assembly; and
a second terminal end coupled to a directed energy combiner in the directed energy head.

15. The directed energy system of claim 14, wherein the directed energy source comprises a plurality of directed energy amplifiers, with each of the directed energy amplifiers independently coupled to a particular one of the plurality of optical fibers at the first terminal end.

16. The directed energy system of claim 15, wherein the directed energy combiner comprises a plurality of directed energy combiners, with each of the directed energy combiners independently coupled to a particular one of the plurality of optical fibers at the second terminal end.

17. The directed energy system of claim 1, wherein the optical energy comprises laser energy.

18. The directed energy system of claim 1, wherein the first axis comprises an azimuthal axis, and the turret is configured to rotate about a plurality of 360 rotations of the azimuthal axis.

19. The directed energy system of claim 18, wherein the second axis comprises an elevation axis, and the directed energy head is configured to rotate about 100 degrees of the elevation axis.

20. A method of delivering directed energy, comprising:
operating a directed energy system that comprises:
a gimbal assembly comprising a turret and a directed energy head coupled to the turret, and
an optical fiber spooling ring comprised of a fiber cable at least partially threaded through the gimbal assembly and comprising a plurality of optical fibers, the optical fiber spooling ring comprising a plurality of 360 degree rotations of the fiber cable;
delivering optical energy through the plurality of optical fibers;
controlling the turret to rotate about a first axis during delivery of the optical energy through the plurality of optical fibers; and
controlling the directed energy head about a second axis orthogonal to the first axis during delivery of the optical energy through the plurality of optical fibers.

21. The method of claim 20, wherein the optical fiber spooling ring is configured as a coil spring that is defined by a first length in a retracted state and a second length greater than the first length in an extended state.

22. The method of claim 21, further comprising, during rotation of the turret about the first axis for a first plurality of 360 degree rotations in a first rotational direction, extending the optical fiber spooling ring from the first length in the retracted state toward the second length.

23. The method of claim 22, further comprising, during rotation of the turret about the first axis for a second plurality of 360 degree rotations in a second rotational direction opposite the first rotational direction, retracting the optical fiber spooling ring from the second length in the extended state toward the first length.

24. The method of claim 23, wherein the optical fiber spooling ring is biased to adjust from the extended state toward the retracted state during rotational movement in the second rotational direction.

25. The method of claim 20, wherein the fiber cable comprises a ribbon cable comprised of the plurality of optical fibers connected in a web.

26. The method of claim 20, further comprising delivering the optical energy in a range of 10 Watts to 1000 Watts.

27. The method of claim 20, wherein the plurality of 360 rotations is between two 360 degree rotations and thirty 360 degree rotations.

28. The method of claim 20, wherein the plurality of 360 rotations comprises more than one 360 degree plus n rotations of the fiber cable, where n is a fraction of a 360 degree rotation of the fiber cable.

29. The method of claim 20, wherein the optical fiber spooling ring is positioned in the turret, and the fiber cable is at least partially threaded from the turret through the directed energy head.

30. The method of claim 20, wherein the optical fiber spooling ring is positioned in a base of the gimbal assembly, and the fiber cable is at least partially threaded from the base and to the directed energy head.

31. The method of claim 20, wherein the optical fiber spooling ring is positioned in a yoke of the gimbal assembly, and the fiber cable is at least partially threaded from the yoke to the directed energy head.

32. The method of claim 20, wherein the optical fiber spooling ring is positioned in the directed energy head.

33. The method of claim 20, further comprising:
delivering the optical energy from a directed energy source to a first terminal end of the fiber cable coupled to the directed energy source external to the gimbal assembly; and
delivering the optical energy from a second terminal end of the fiber cable coupled to a directed energy combiner in the directed energy head.

34. The method of claim 33, wherein the directed energy source comprises a plurality of directed energy amplifiers, with each of the directed energy amplifiers independently coupled to a particular one of the plurality of optical fibers at the first terminal end.

35. The method of claim 34, wherein the directed energy combiner comprises a plurality of directed energy combiners, with each of the directed energy combiners independently coupled to a particular one of the plurality of optical fibers at the second terminal end.

36. The method of claim 20, wherein the optical energy comprises laser energy.

37. The method of claim 20, wherein the first axis comprises an azimuthal axis, and
controlling the turret to rotate about the first axis during delivery of the optical energy through the plurality of optical fibers comprises controlling the turret to rotate about a plurality of 360 rotations of the azimuthal axis.

38. The method of claim 37, wherein the second axis comprises an elevation axis, and
controlling the directed energy head about the second axis orthogonal to the first axis during delivery of the optical energy through the plurality of optical fibers comprises controlling the directed energy head to rotate about 100 degrees of the elevation axis.
